(19) United States
(12) Patent Application Publication
(10) Pub. No.: US 2023/0415524 A1
(43) Pub. Date: Dec. 28, 2023

(54) TIRE POSITION IDENTIFICATION DEVICE AND TIRE POSITION IDENTIFICATION METHOD

(71) Applicant: ALPS ALPINE CO., LTD., Tokyo (JP)

(72) Inventors: Heishiro FUDO, Miyagi-ken (JP); Eiji SHINOHARA, Niigata-ken (JP); Shinya ICHISE, Miyagi-ken (JP); Hiroyuki TOBARI, Miyagi-ken (JP); Yuki ONO, Niigata-ken (JP); Masanaga TAKAHASHI, Miyagi-ken (JP)

(73) Assignee: ALPS ALPINE CO., LTD., Tokyo (JP)

(21) Appl. No.: 18/463,814

(22) Filed: Sep. 8, 2023

Related U.S. Application Data
(63) Continuation of application No. PCT/JP2022/002465, filed on Jan. 24, 2022.

(30) Foreign Application Priority Data
Mar. 11, 2021 (JP) 2021-039707

(51) Int. Cl. B60C 23/04

(52) U.S. Cl. CPC B60C 23/0416; B60C 23/0488

(57) ABSTRACT

A tire position identification device is provided as a device that can identify the positions of wheels to which tires are attached by using information about other than air pressure. The tire position identification device has: deformation detection units, each of which can detect deformation of the relevant tire; a turn detection unit that can detect whether a vehicle having the tires and wheels has made a turn and can also detect the direction of the turn; a speed detection unit that can detect the speed of the vehicle, and a control unit that infers the positions of the wheels to which the tires are attached according to the deformation of the tires, the direction of the turn of the vehicle, and its speed.

### CLAIM OF PRIORITY

This application is a Continuation of International Application No. PCT/JP2022/002465 filed on Jan. 24, 2022, which claims benefit of Japanese Patent Application No. 2021-039707 filed on Mar. 11, 2021. The entire contents of each application noted above are hereby incorporated by reference.

### BACKGROUND OF THE INVENTION

### 1. Field of the Invention

The present invention relates to a tire position identification device that identifies the position of a wheel to which a tire is attached and to a tire position identification method.

### 2. Description of the Related Art

Application of a sensor that measures tire's physical quantities to a tire for use for a vehicle is being pursued in recent years. The sensor detects air pressure and temperature in the tire, transmits detection results to the vehicle's body, and, if necessary, issues an alarm. Examples of sensors of this type include a tire pressure monitoring system (TPMS). When a new TPMS is installed, a tire is replaced after the installation, or tire rotation is performed to change the position of the tires, a correspondence between the tire and the sensor needs to be newly set or set again. This is a complicated job. In view of this, in management of information from the sensor, it is necessary to decide that information transmitted from the sensor to the vehicle's body is about which tire and then to identify the position of the wheel to which the tire is attached.

In Japanese Unexamined Patent Application Publication No. 2014-108718, for example, a tire position discrimination device is described that has an air pressure detection unit, a wireless communication unit, a turn detection unit, a data storage unit, and a tire position discrimination means for calculating the amount of increase in air pressure in each tire from time-series data stored in the data storage unit, comparing the amount of increase in air pressure among the tires, and discriminating tire positions by using data of the turn direction of the vehicle and data of the increase in air pressure in each tire.

However, since air pressure in a tire is likely to be affected by external factors, error is likely to occur in measurement of air pressure in each tire. External factors that affect air pressure include deformation caused when the tire runs over a stone or the like and expansion and contraction of the tire due to variations in outside air temperatures. Another problem is that when, for example, a centrifugal force caused by a turn is small, if the difference in the amount of increase in air pressure in each tire is small, it is difficult to decide position of the wheel to which each tire is attached.

The present invention provides a tire position identification device that can identify the position of a wheel to which a tire is attached by using information about other than air pressure and a tire position identification method.

### SUMMARY OF THE INVENTION

In the present invention provided to address the above problems, a tire position identification device that identifies the position of a wheel to which a tire is attached has: a deformation detection unit capable of detecting deformation of the tire; a turn detection unit capable of detecting whether a vehicle having the tire and the wheel has made a turn and also detecting a turn direction; a speed detection unit capable of detecting the speed of the vehicle; and a position inference unit that infers the position of the wheel to which the tire is attached, according to the deformation, the turn direction, and the speed.

In this structure, the position of a wheel to which a tire is attached can be identified according to periodic deformation caused by the rotation of the tire, a turn direction of the vehicle, and the speed of the vehicle, without using information about air pressure in the tire.

The position inference unit may make a first decision in which the position inference unit decides that the tire is attached to the wheel on which side, an outer side or an inner side, with respect to the center of a turn of the vehicle, by using the revolution speed of the tire at the time when the turn of the vehicle is detected by the turn detection unit, the revolution speed being detected according to the deformation of the tire, as well as a second decision in which the position inference unit decides that the tire is attached to the wheel in which direction of the vehicle, forward or backward, by using a load to the tire at the time when a change in speed is detected by the speed detection unit while the vehicle is traveling straight ahead, the load being detected according to the deformation of the tire, and may make a third decision in which the position inference unit makes a decision about the position of the wheel to which the tire is attached according to results in the first decision and the second decision.

In the first decision, when a right turn of the vehicle is detected and when a left turn is detected, a decision may be made as to on which side the tire is attached to the wheel, the outer side or the inner side, with respect to the center of the turn of the tire, by using the revolution speed of the tire, the revolution speed being detected according to the deformation of the tire.

By using results about the turns in both directions, it is possible to more accurately make a decision about the position of the wheel to which the tire is attached.

The vehicle may have wheels as front wheels, one on each side in a left-right direction, and also has wheel as rear wheels one on each side in the left-right direction. In the first decision, the tires may be ranked in descending order of the revolution speed. The tires ranked in a first place and a second place in terms of the revolution speed may be decided to be attached to the wheels on a side distant from the center of the turn of the vehicle. The tires ranked in a third place and a fourth place in terms of the revolution speed may be decided to be attached to the wheels on a side close to the center of the turn of the vehicle. In the second decision, when deceleration is detected by the speed detection unit, the tires may be ranked in descending order of the magnitude of the load applied to the tire. The tires ranked in a first place and a second place in terms of the magnitude of the load may be decided to be attached to the front wheels, and the tires ranked in a third place and a fourth place in terms of the magnitude of the load may be decided to be attached to the rear wheels.

With the vehicle, wheels may be arranged on each of the left and right on the front side of the vehicle in n rows (n≥1) in the front-back direction as the front wheels and wheels may be arranged on each of the left and right on the rear side of the vehicle in m rows (m≥1) in the front-back direction as the rear wheels. In the first decision, the tires may be ranked in descending order of the revolution speed. The tires ranked in a first place to an (n+m)th place in terms of the revolution speed may be decided to be attached to the wheels distant from the center of the turn of the vehicle. In the second decision, the tires may be ranked in descending order of the magnitude of the load at the time when deceleration is detected by the speed detection unit. The tires to which the magnitudes of the loads ranked in a first place to a (2×n)th place are applied may be decided to be attached to the front wheels.

In the second decision, an interval between peaks in a graph indicating the deformation may be used to decide that as the interval between the peaks becomes longer, the magnitude of the load is larger.

The position inference unit may make a first decision in which the position inference unit decides on which side the tire is attached to the wheel, an outer side or an inner side, with respect to the center of the turn of the vehicle, by using the revolution speed of the tire at the time when the turn of the vehicle is detected by the turn detection unit, the revolution speed being detected according to the deformation, as well as a fourth decision in which the position inference unit decides which wheel, a driving wheel or a non-driving wheel, the tire is attached to, according to the revolution speed of the tire at the time when acceleration is detected by the speed detection unit while the vehicle is traveling straight ahead, the revolution speed being detected by using the deformation, and may make a fifth decision in which the position inference unit makes a decision about the position of the wheel to which the tire is attached according to results in the first decision and the fourth decision.

In the first decision, the tires are ranked in descending order of the revolution speed. A top half may be decided to be attached to the wheels on the outer side with respect to the center of the turn, and a bottom half may be decided to be attached to the wheels on the inner side with respect to the center of the turn. In the fourth decision, the tires may be ranked in descending order of the revolution speed at the time when acceleration is detected by the speed detection unit. Tires in as many top places as there are driving wheels may be decided to be attached to the driving wheels, and the remaining tires may be decided to be attached to the non-driving wheels.

The position inference unit may infer the position of the wheel to which the tire is attached, according to the deformation of the tire that continuously rotates five times or more, the turn direction, and the speed.

The position inference unit may also infer the position of the wheel to which the tire is attached, according to the deformation, the turn direction, and the speed while the vehicle is traveling at a speed of 50 km/h or less.

The tire position identification device of the present invention may have a wear state detection unit that detects a wear state of the tire according to the deformation of the tire.

The tire position identification method of the present invention provided to address the above problems is a tire position identification method of identifying the position of a wheel to which a tire is attached, the method including: detecting deformation of the tire; detecting whether a vehicle having the tire and the wheel has made a turn as well as a turn direction; detecting a speed of the vehicle; and inferring the position of the wheel to which the tire is attached according to the deformation, the turn direction, and the speed.

The present invention can infer the position of a wheel to which a tire is attached according to deformation of the tire, a turn direction of a vehicle, and its speed rather than pressure in the tire. Therefore, the present invention can provide a tire position identification device that can stably and efficiently identify a tire position without being affected by variations in pressure in the tire and a tire position identification method.

### BRIEF DESCRIPTION OF THE DRAWINGS

FIG. 1A is a block diagram of a tire position identification device according to a first embodiment, and FIG. 1B is a block diagram of a tire-side unit;

FIG. 2A is a schematic diagram illustrating tire deformation caused by rotation, and FIG. 2B is a graph of waveforms illustrating changes in tire deformation velocity (solid line) and the amount of deformation (broken line);

FIG. 3A is a graph illustrating outputs, in response to continuous tire rotation, from a deformation detection unit, and FIG. 3B is a graph illustrating outputs from the deformation detection unit;

FIG. 4A is a graph illustrating outputs from the deformation detection unit during acceleration, and FIG. 4B is a graph illustrating outputs from the deformation detection unit during deceleration;

FIG. 5 is a graph illustrating outputs from deformation detection units on a driving wheel and a non-driving wheel during turning;

FIG. 6 is a graph illustrating outputs from deformation detection units on a front wheel and a rear wheel at the time of acceleration (start);

FIG. 7 is a flowchart for tire position identification (left and right, first decision);

FIG. 8 is a flowchart for tire position identification (front and rear, second decision);

FIG. 9 is a flowchart for tire position identification (attachment position, third decision);

FIG. 10 is a flowchart for tire position identification (driving and non-driving, fourth decision);

FIG. 11 is a flowchart for tire position identification (attachment position, fifth decision);

FIG. 12 is a block diagram of a tire position identification device according to a second embodiment;

FIG. 13 is a flowchart for tire position identification (left and right, first decision);

FIG. 14 is a flowchart for tire position identification (front and rear, second decision); and

FIG. 15 is a flowchart for tire position identification (attachment position, third decision).

### DESCRIPTION OF THE PREFERRED EMBODIMENTS

Embodiments of the present invention will be described below with reference to the drawings. Members having the same function in the drawings are assigned the same reference numeral, and their description will be appropriately omitted.

### First Embodiment

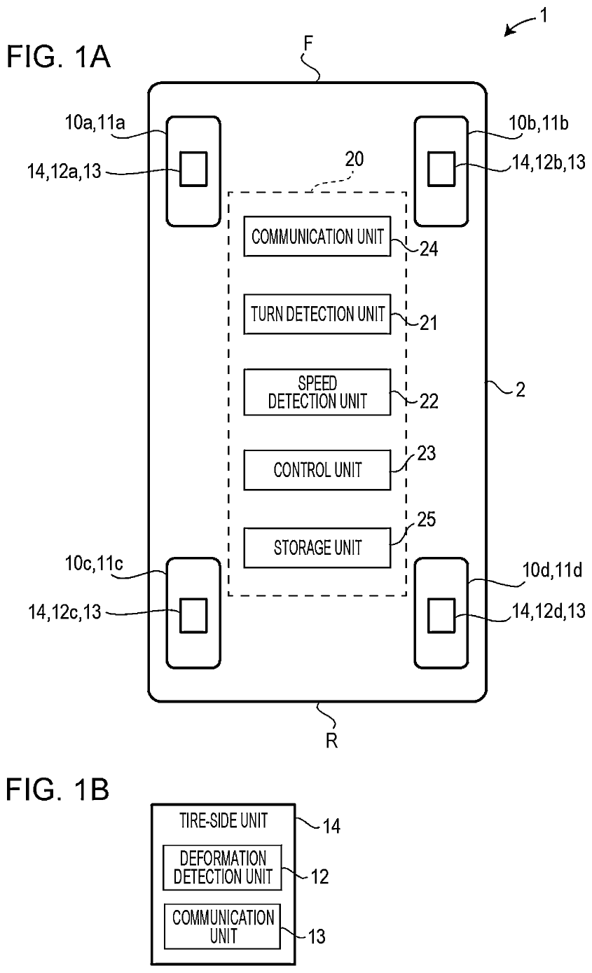

FIG. 1A is a block diagram of a tire position identification device 1 according to this embodiment, and FIG. 1B is a block diagram of a tire-side unit 14. As indicated in the drawings, the tire position identification device 1 identifies the positions of wheels 11a to 11d to which tires 10a to 10d are attached. The tire position identification device 1 has deformation detection units 12a to 12d, a turn detection unit 21, a speed detection unit 22, a control unit 23, a communication unit 24, and a storage unit 25. When the tires 10a to 10d, wheels 11a to 11d, and deformation detection units 12a to 12d are not distinguished, they will be appropriately described below as the tires 10, wheels 11, and deformation detection units 12.

The tire-side unit 14 has a structure (not illustrated) including the deformation detection unit 12, a communication unit 13, a control unit, a power supply, and the like. The tire-side unit 14 is attached to a base attached to, for example, the inner surface of the tire 10 in a detachable state. The tire-side unit 14 may be mounted as part of another device, such as a TPMS, attached to the tire 10.

The deformation detection unit 12 measures deformation of the tire 10, the deformation being caused during rotation, and outputs measurement results through the communication unit 13. The deformation detection unit 12 is attached to each tire 10. According to a change in the output of the deformation detection unit 12, the revolution speed (rotational frequency) of the tire 10, the state of its wear, and the like can be measured. A piezoelectric sensor or a strain gauge can be used as the deformation detection unit 12.

The turn detection unit 21, speed detection unit 22, control unit 23, communication unit 24, and storage unit 25 constitute a vehicle-side unit 20. Devices and functions included in a vehicle 2 may be used as units constituting the vehicle-side unit 20.

The turn detection unit 21 detects whether the vehicle 2 has made a turn during a travel and also detects the direction of the turn. For example, a steering sensor included in the vehicle 2 can be used as the turn detection unit 21.

The speed detection unit 22 detects the speed of the vehicle 2, its acceleration and deceleration, based on a change in speed, at the time of starting and at the time of braking, and the like. For example, a speed sensor and an acceleration sensor included in the vehicle 2 can be used as the speed detection unit 22. A GPS receiver in the vehicle 2, a car navigation system, a mobile terminal, or the like may be used to measure the speed of the vehicle 2. The speed detection unit 22 may calculate a speed according to the revolution speed, measured by the deformation detection unit 12, of the tire 10, instead of using the speed sensor and the like of the vehicle 2. In this case, an output from the deformation detection unit 12 may be used for the vehicle-side unit 20 to calculate a speed or for the tire-side unit 14 to calculate a speed.

The control unit 23 controls the tire position identification device 1. For example, an electronic control unit (ECU) mounted on the vehicle 2 can be used as the control unit 23. The control unit 23 functions as a position inference unit that infers the position of the wheel 11 to which the tire 10 is attached, according to the turn direction detected by the turn detection unit 21, the speed detected by the speed detection unit 22, and the output from the deformation detection unit 12.

The control unit 23 may have a function as a wear state detection unit that detects a wear state of the tire 10 according to the output from the deformation detection unit 12. The wear state of the tire 10 can be evaluated by using, for example, deformation before the treading (before a contact) of the tire 10 or after the kicking-out (after a contact) of the tire 10 and deformation at the time of the contact of the tire 10.

The communication unit 24, which is used for communication between the tire-side unit 14 and the vehicle-side unit 20, receives an output from the deformation detection unit 12 in the tire-side unit 14. The communication unit 24 may output a signal or the like related to a command of some kind to the tire-side unit 14, as necessary. An example of the command is a command related to control of the deformation detection unit 12 in the tire-side unit 14.

The storage unit 25 records detection results, decision results, and information used in detection and decision. A recording means provided in the vehicle 2 can be used as the storage unit 25. Information used in detection and decision include predetermined values, predetermined threshold values, information as to whether the wheel 11 of the vehicle 2 is a driving wheel or a non-driving wheel, and the like, which are used in first to fifth decisions described later.

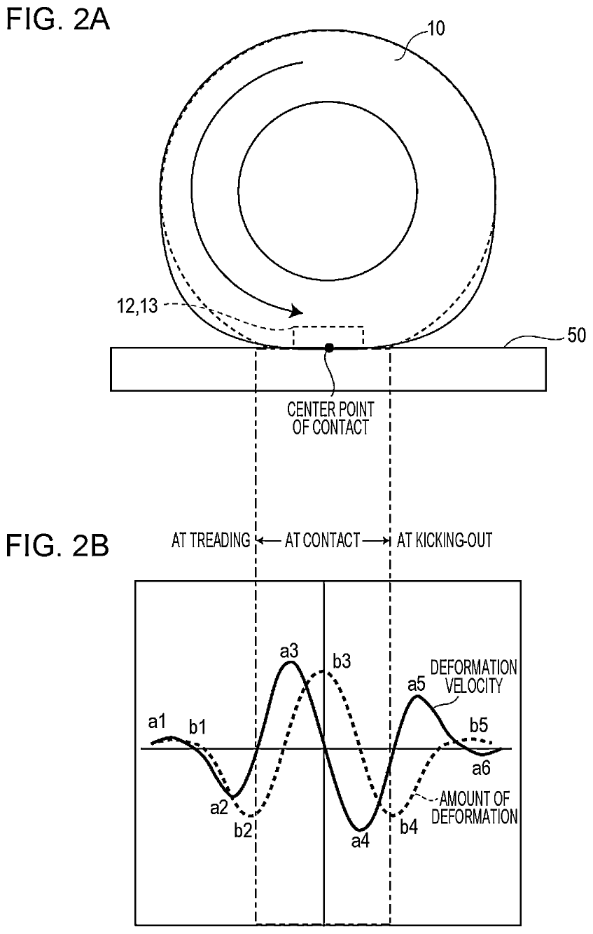

FIG. 2A is a front view schematically illustrating deformation while the tire 10 is rotating. FIG. 2B is waveforms schematically illustrating time-series changes in tire deformation velocity and in the amount of tire deformation, which are measured by the deformation detection unit 12 at the tire 10 during its rotation. In the drawing, the solid line indicates time-series changes in tire deformation velocity and the broken line indicates time-series changes in the amount of tire deformation. In the drawing, the horizontal axis indicates time and the vertical axis indicates the tire deformation velocity and the amount of tire deformation. The solid line and broken line respectively indicate waveforms of time-series changes in tire deformation velocity and in the amount of tire deformation in schematic form. The graph in FIG. 2B is plotted in time series from the left side toward the right side.

As illustrated in FIG. 2A, the deformation detection unit 12 measures the deformation, of the tire 10, that is caused when treading, contact, and kicking-out on a road surface 50 are repeated at a portion at which the deformation detection unit 12 is placed while the tire 10 is rotating, and measures periodic changes of the tire 10 in response to the rotation.

As indicated in FIGS. 2A and 2B, when the tire 10 rotates, an arbitrary portion of the tire 10 is more greatly deformed when treading, contact, and kicking-out are performed on the road surface 50. When the deformation detection unit 12 is placed on the inner surface of the tire the deformation detection unit 12 periodically measures the deformation of the tire 10 at the time of the treading, contact, and kicking-out at the portion at which the deformation detection unit 12 is placed.

In this description, peaks of the tire deformation velocity indicated by the solid line in the graph in FIG. 2B are appropriately referred to as peaks a1 to a6, and peaks of the amount of tire deformation indicated by the broken line are appropriately referred to as peaks b1 to b5. Various types of information about the tire 10 can be obtained from these peaks. For example, a time interval between the peak a3 and the peak a4 can be used as an index for the magnitude of the load to the tire 10. The load to the tire 10 may be measured by using other than the amount of the deformation of the tire. For example, a load to the tire 10 may be measured by using a load sensor attached to the suspension of the vehicle 2.

The magnitudes of the peaks a1 to a6 can also be used as an index for a deterioration state of the tire 10 such as wear. In this case, it is preferable to use the maximum value of the tire deformation velocity before or after a tire contact and a second peak, which is the maximum value of the tire deformation velocity at the time of the tire contact, in combination. For example, values (a2/a3), (a2/a4), (a5/a3), and (a5/a4), obtained by dividing the peak value of the peak a2 or peak a5 by the peak value of the peak a3 or peak a4, and the like can be used as indexes with which the wear of the tire 10 is evaluated.

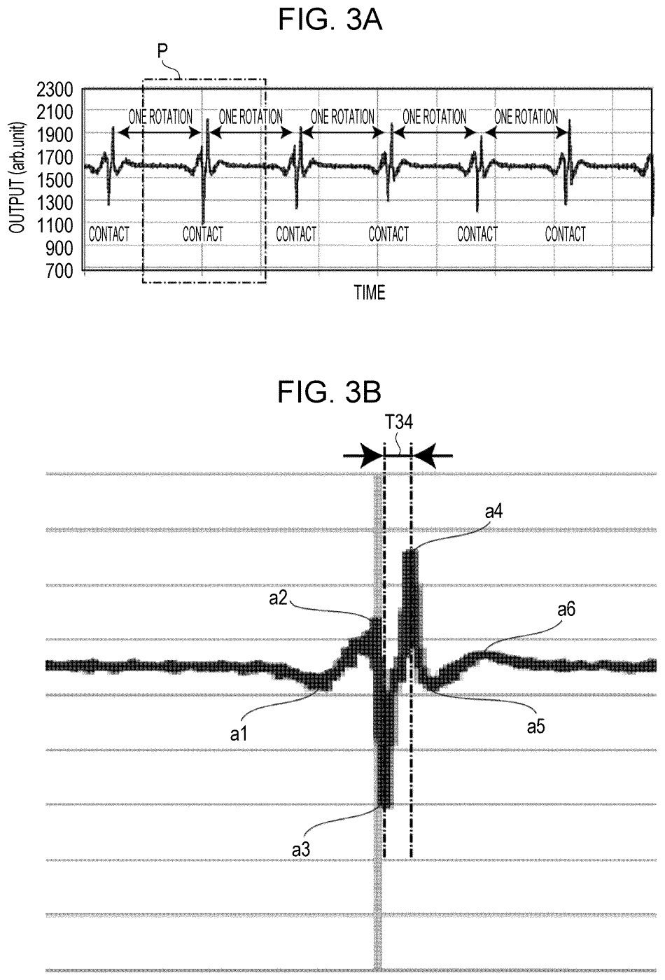

FIG. 3A is a graph illustrating outputs from the deformation detection unit 12 in response to the rotation of the tire 10. When the tire 10 rotates, each time the rear surface (tread portion) of the portion to which the deformation detection unit 12 is attached comes into contact with the ground surface, a different output is obtained. The graph in the drawing illustrates outputs for a plurality of rotations together. The output from the deformation detection unit 12 changes in a periodic pattern in response to the rotation of the tire 10. Therefore, when portions at great output changes are counted, the revolution speed of the tire 10 can be measured.

FIG. 3B is a graph illustrating an example of outputs from the deformation detection unit 12. The area P, enclosed by the dashed lines, in FIG. 3A is indicated by being enlarged. Outputs in this graph correspond to changes, in tire deformation velocity, indicated by the solid line in FIG. 2B. Times at which the tire deformation velocity becomes the peaks a1 to a6 can be identified. In the description below, a time interval between the peak a3 and the peak a4 before and after the contact of a surface of the tire 10, the surface being opposite to the surface to which the deformation detection unit 12, is attached will be referred to as a time interval T34.

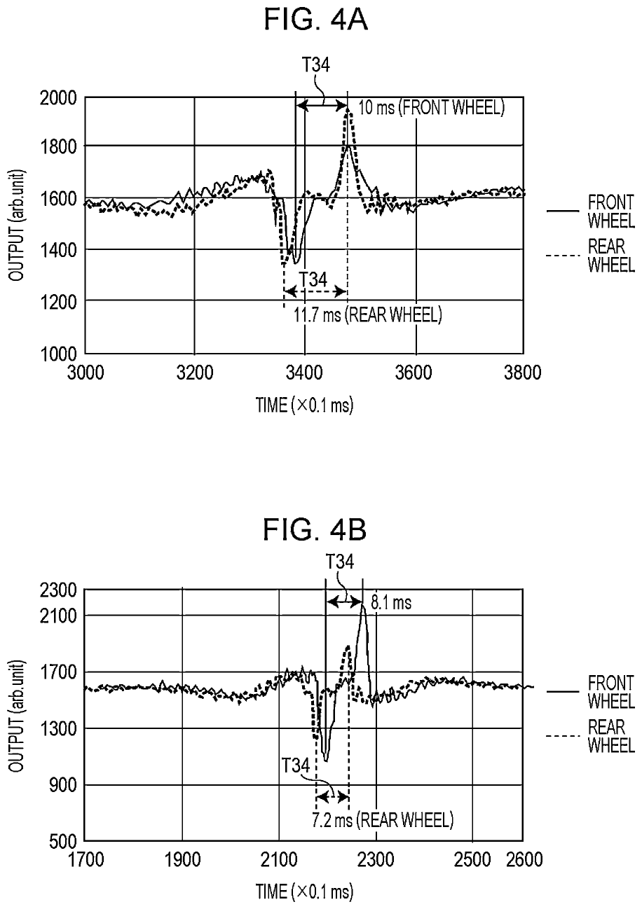

FIG. 4A is a graph illustrating outputs from the deformation detection unit 12 when the speed of the vehicle 2 during acceleration is 35 km per hour. FIG. 4B is a graph illustrating outputs from the deformation detection unit 12 when the speed of the vehicle 2 during deceleration is 51 km per hour. These graphs indicate measurement results for an ordinary vehicle having four tires 10.

As illustrated in these drawings, it was found that between the tires 10a and 10b of the front wheels (wheels 11a and 11b) and the tires 10c and 10d of the rear wheels (wheels 11c and 11d), there is a difference in time interval (particularly, the time interval T34) between peaks of outputs from the deformation detection unit 12 both during acceleration and during deceleration. Therefore, it can be inferred, through a comparison of outputs from the deformation detection units 12, that the tire 10 has been attached to which wheel 11, the front wheel or rear wheel.

TABLE 1

| | T34 (ms) | | Ratio (%) |
|---|---|---|---|
| | Front-wheel | Rear-wheel | Rear wheel/ |
| | tire | tire | front wheel |
| During acceleration | 10.0 | 11.7 | 117 |
| During deceleration | 8.1 | 7.2 | 89 |

As indicated in Table 1, during the acceleration of the vehicle 2, the time interval T34 for the tire 10 of the rear wheel is longer than the time interval T34 for the tire 10 of the front wheel. Therefore, it is decided that the tires 10 corresponding to the longest time interval T34 and second longest time interval T34 of the four tires 10 are attached to the rear wheels and the tires 10 corresponding to the third longest time interval T34 and fourth longest time interval T34 are attached to the front wheels. Conversely to this, during the deceleration of the vehicle 2, the time interval T34 for the tire 10 of the rear wheel is smaller than the time interval T34 for the tire 10 of the front wheel. Therefore, it is decided that the tires 10 corresponding to the longest time interval T34 and second longest time interval T34 of the four tires 10 are attached to the front wheels and the tires 10 corresponding to the third longest time interval T34 and fourth longest time interval T34 are attached to the rear wheels.

Although, through measurement either during the acceleration of the vehicle 2 or during its deceleration, the position of the tire 10 (specifically, which wheel, the front wheel or rear wheel, the tire 10 is attached to) can be inferred as described above, measurement results for both may be used. When measurement results for both during acceleration and during deceleration are used, the position of the tire 10 can be more precisely inferred.

The time interval T34 reflects the magnitude of distortion caused in the tire 10. As the time interval T34 between peaks of outputs from the deformation detection unit 12 becomes longer, the magnitude of the load to the tire 10 can be evaluated to be larger.

When the time interval T34 becomes longer as an external force exerted on the tire 10 becomes larger, the distortion of the tire 10 becomes larger. During acceleration at the time of starting or the like, the center of gravity of the vehicle 2 shifts backward and the load exerted on the tire 10 of the rear wheel thereby becomes larger than the load exerted on the front wheel. Therefore, the distortion of the tire 10 of the rear wheel becomes larger than the distortion of the tire 10 of the front wheel, and the time interval T34 of the tire 10 of the rear wheel thereby becomes larger the time interval T34 of the tire 10 of the front wheel.

Conversely, during deceleration at the time of braking or the like, the load to the vehicle 2 shifts forward and a load exerted on the tire 10 of the rear wheel thereby becomes smaller than a load exerted on the tire 10 of the front wheel. Therefore, the distortion of the tire 10 of the rear wheel becomes smaller than the distortion of the tire 10 of the front wheel, and the time interval T34 of the tire 10 of the rear wheel thereby becomes smaller than the time interval T34 of the tire 10 of the front wheel. When the shift of a load during the acceleration or deceleration of the vehicle 2 is detected by using the time interval T34 from the peak a3 to the peak a4 of outputs of the deformation detection unit 12 as described above, it can be decided that the tire 10 is attached to which wheel, the front wheel or rear wheel.

Since a load shift can be detected from the time interval T34, a decision can be made about a position in the front-back direction even when the vehicle 2 is a truck, a bus, or the like having six or more tires 10.

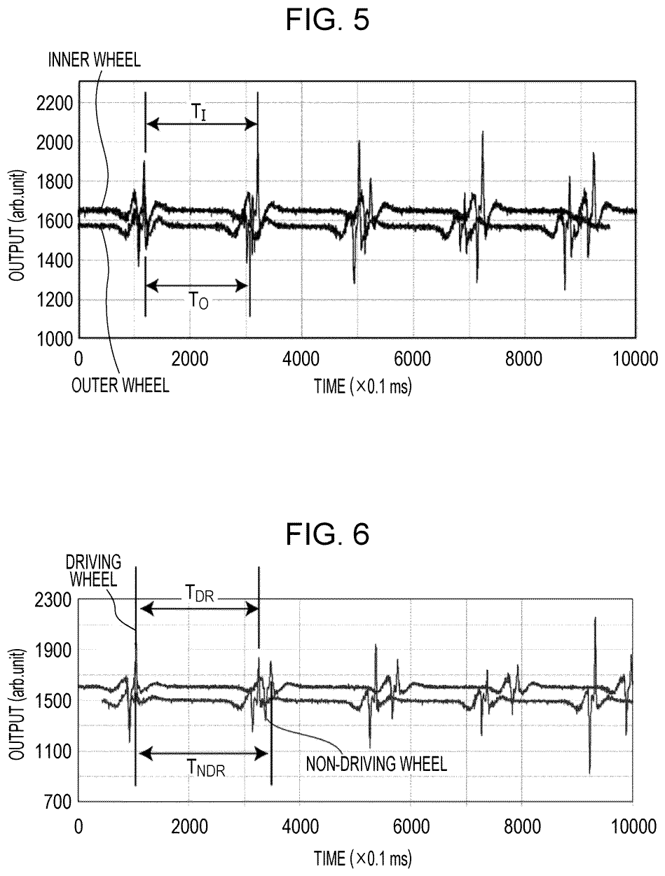

FIG. 5 is a graph illustrating outputs from the deformation detection units 12 on an inner wheel and on an outer wheel with respect to the center of a turn while the front wheels of the tires 10 attached to the vehicle 2 rotate five times during a turn of the vehicle 2 in the left direction. As described above, the revolution speed of the tire 10 to which the deformation detection unit 12 is attached and the rotational period of the tire 10 are found from outputs from the deformation detection unit 12. When the revolution speed and rotational period are used, it can be decided that the tire 10 is attached to which wheel, the inner wheel or outer wheel, of the vehicle 2.

As illustrated in the drawing, during a left turn, the rotational period T_{I} of the tires 10a and 10c attached to the left side of the vehicle 2 is longer than the rotational period T_{O} of the tires 10b and 10d attached to the right side of the vehicle 2. During a turn, therefore, the revolution speed of the tires 10a and 10c attached to the inner wheels is higher than the revolution speed of the tires 10b and 10d attached to the outer wheels.

As described above, it was found that the tire 10 on a side on which the radius of a turn path is large (that is, the outer side) has a shorter rotational period and a higher revolution speed than the tire 10 on a side on which the radius of a turn path is small (that is, the inner side). Since, for each tire 10, the rotational period and revolution speed can be identified according to outputs from the deformation detection unit 12, it can be decided by using outputs from the deformation detection unit 12 during a turn that the tire 10 is attached to the wheel 11 on which side, the inner side or outer side.

FIG. 6 is a graph illustrating outputs for five rotations of the tire 10 from the deformation detection units 12 on a driving wheel and on a non-driving wheel at the time of the starting of the vehicle 2. The drawing illustrates measurement results when the vehicle 2 is a front-engine rear-drive (FR) (RF) vehicle. Specifically, the drawing illustrates outputs from the deformation detection units 12 that measured deformation of the tires 10 of the vehicle 2 for which the rear wheels to which the tires 10c and 10d are attached are the driving wheels and the front wheels to which the tires 10a and 10b are attached area the non-driving wheels.

As illustrated in the drawing, the rotational period T_{DR} of the tires 10c and 10d attached to the rear wheels, which are the driving wheels, is shorter than the rotational period T_{NDR} of the tires 10a and 10b attached to the front wheels, which are the non-driving wheels. At the time of the start of the vehicle 2, therefore, the revolution speed of the tires 10c and 10d of the driving wheels is higher than the revolution speed of the tires 10a and 10b of the non-driving wheels.

As described above, it was found that the tire 10 of the driving wheel has a shorter rotational period and a higher revolution speed than the tire 10 of the non-driving wheel. Since the rotational period of each tire 10 and its revolution speed can be identified according to outputs from the deformation detection unit 12, it can be decided by using outputs from the deformation detection unit 12 at the time of start that the tire 10 is attached to which wheel, the driving wheel or non-driving wheel.

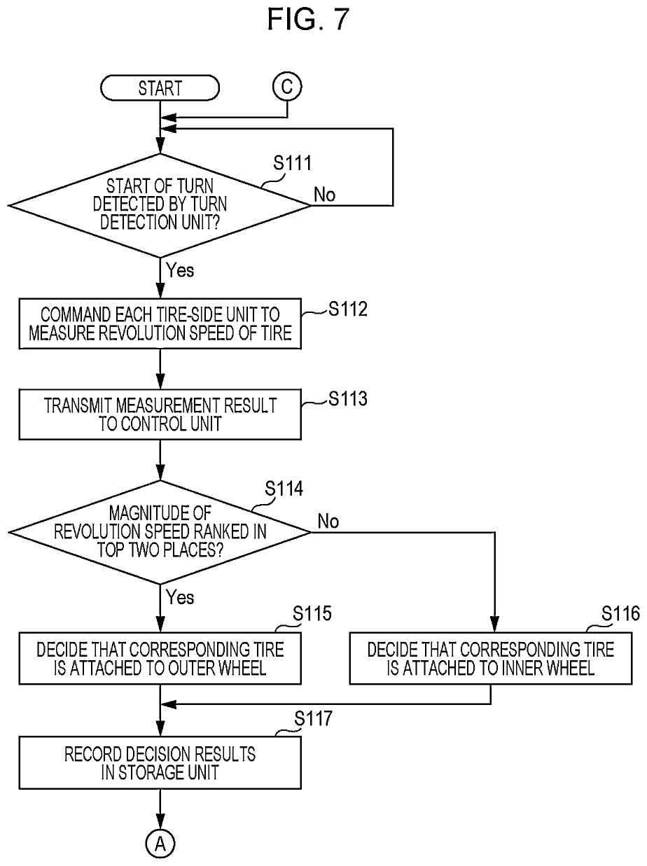

A tire position identification process executed in the tire position identification device 1 will be described below with reference to FIGS. 7 to 11.

### First Decision

FIG. 7 is a flowchart illustrating a first decision, in which it is decided in a position inference process that the tire 10 is attached to which wheel 11, a left wheel or a right wheel.

When the position inference process starts, the turn detection unit 21 (see FIG. 1A) detects whether a turn of the vehicle 2 has been started (S111). If the turn detection unit 21 has not detected the start of a turn (No in S111), the turn detection unit 21 continues to detect the start of a turn. If the turn detection unit 21 has detected the start of a turn (Yes in S111), the control unit 23 commands each tire-side unit 14 to measure the revolution speed of the relevant tire 10 (S112). Next, each tire-side unit 14 transmits a measurement result to the control unit 23 through the communication unit 13 and communication unit 24 (S113).

By using the revolution speeds, of the tires 10, that were detected according the outputs of the deformation detection units 12, the outputs being measurement results sent from four tire-side units 14, the control unit 23 decides whether the revolution speed of each tire 10 to which the tire-side unit 14 is attached is ranked in top two places (S114). The outputs from the deformation detection unit 12, the output being used in the detection of the revolution speed in the decision in S114, are preferably measurement results for the behavior of the tire 10 that continuously rotated five times or more, and are also preferably measurement results when the vehicle 2 is traveling at a speed of 50 km/h or less, which is, for example, at a speed of 20 km/h or more and 50 km/h or less.

If the control unit 23 decides that the revolution speed of the tire 10 is ranked in top two places (Yes in S114), the control unit 23 decides that the tire 10 is attached to an outer wheel, that is, the wheel 11 on a side distant from the center of the turn detected in S111 (S115).

If the control unit 23 decides that the revolution speed of the tire 10 is not ranked in top two places (No in S114), the control unit 23 decides that the tire 10 is attached to an inner wheel, that is, the wheel 11 on a side close to the center of the turn detected in S111 (S116).

Next, the control unit 23 records, in the storage unit the decision results in S115 and S116 (S117), and executes the position inference process for four wheels, which will be described later. However, the control unit 23 may shift directly from S115 or S116 to the position inference process for four wheels without performing recording in S117.

The first decision illustrated in FIG. 7 may be made when a right turn of the vehicle 2 is detected in S111 and when a left turn is detected in S111. In this case, when a match is found between a decision result recorded in the storage unit 25 in advance and a decision result when a turn in the opposite direction is detected, it may be determined that the tire 10 is attached to which wheel 11, a left wheel or a right wheel.

As described above, for the vehicle 2 that may have wheels 11 as the front wheels, one on each of the left and right sides, and may also have wheels 11 as the rear wheels, one on each of the left and right sides, the tire position identification device 1 may rank the tires 10 in descending order of the revolution speed, and may decide that the tires 10 ranked in the first place and second place in terms of the revolution speed are attached to the wheels 11 on the side distant from the center of the turn of the vehicle 2 and that the tires 10 ranked in the third place and fourth place in terms of the revolution speed are attached to the wheels 11 on the side close to the center of the turn of the vehicle 2.

### Second Decision

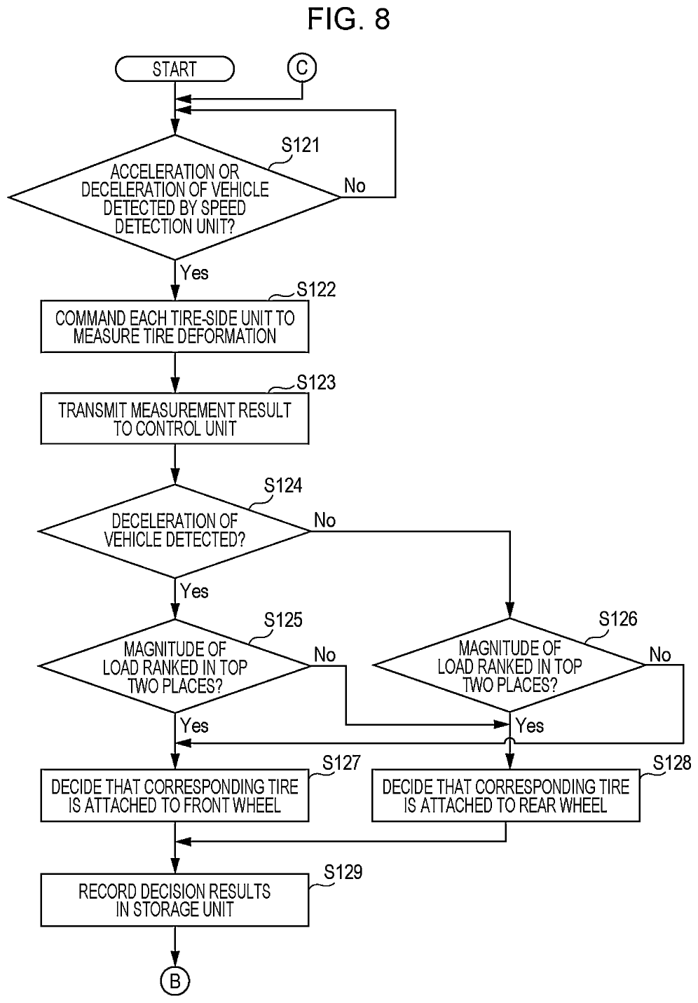

FIG. 8 is a flowchart for a process in a second decision, in the position inference process, in which it is decided that the tire 10 is attached to which wheel 11, a front wheel or a rear wheel.

When the position inference process starts, the speed detection unit 22 detects whether the vehicle 2 has been accelerated or decelerated while the vehicle 2 is traveling straight ahead (S121). When, for example, the speed detection unit 22 detects acceleration from a speed of 0 km/h to 50 km/h or deceleration from a speed of 50 km/h to 0 km/h in 1 to 10 seconds, if the speed detection unit 22 detects acceleration from 1.3 m/s² to 13 m/s² or −13 m/s² to −1.3 m/s², the speed detection unit 22 detects the acceleration or deceleration of the vehicle 2.

If the speed detection unit 22 detects neither acceleration nor deceleration (No in S121), the speed detection unit 22 continues to detect acceleration or deceleration. If the speed detection unit 22 detects acceleration or deceleration (Yes in S121), the control unit 23 commands each tire-side unit 14 to measure the deformation of the relevant tire 10 (S122). Next, each tire-side unit 14 transmits a measurement result to the control unit 23 through the communication unit 13 and communication unit 24 (S123). The measurement result transmitted in S123 is preferably a result obtained in the measurement of the behavior of the tire 10 that rotates continuously five times or more, and is preferably a result of measurement performed while the vehicle 2 is traveling at a speed of 50 km/h or less, which is, for example, at a speed of 20 km/h or more and 50 km/h or less.

If the deceleration of the vehicle 2 is detected in S124 (Yes in S124), the control unit 23 decides whether the magnitude of a load applied to the tire 10 to which the tire-side unit 14 is attached is ranked in the top two places, by using the measurement results transmitted from the four tire-side units 14 (S125).

If the control unit 23 decides that the magnitude of the load to the tire 10 is ranked in the top two places (Yes in S125), the control unit 23 decides that the tire 10 is attached to a front wheel (S127).

If the control unit 23 decides that the magnitude of the load to the tire 10 is not ranked in the top two places (No in S125), the control unit 23 decides that the tire 10 is attached to a rear wheel (S128).

If the acceleration of the vehicle 2 rather than deceleration is detected in S124 (No in 124), the control unit 23 decides whether the magnitude of the load applied to each tire 10 is ranked in the top two places, by using the measurement results from the tire-side units 14 (S126).

If acceleration is detected, the relationship of the magnitudes of the loads to the tires 10 at the front and rear is opposite to when deceleration is detected (S125). Therefore, if the control unit 23 decides that the load to the tire 10 is ranked in the top two places (Yes in S126), the control unit 23 decides that the tire 10 is attached to a rear wheel (S128). If the control unit 23 decides that the load to the tire 10 is not ranked in the top two places (No in S126), the control unit 23 decides that the tire 10 is attached to a front wheel (S127).

Next, the control unit 23 records, in the storage unit the decision results in S127 and S128 (S129), and executes the position inference process for four wheels, which will be described later. However, the control unit 23 may shift directly from S127 or S128 to the position inference process for four wheels without performing recording in S129.

The second decision illustrated in FIG. 8 may be made when the acceleration of the vehicle 2 is detected in S121 and when deceleration is detected in S121. In this case, when a match is found between a decision result recorded in the storage unit 25 in advance for one of deceleration and acceleration and a decision result for the other, it may be determined that the tire 10 is attached to which wheel 11, a front wheel or a rear wheel.

In the process described above, the tire position identification device 1 in this embodiment may rank the tires in descending order of the magnitude of the load applied to the tires 10 at the time when deceleration is detected by the speed detection unit 22, and may decide that the tires 10 ranked in the first place and second place in terms of the load are attached to the front wheels and that the tires 10 ranked in the third place and fourth place in terms of the load are attached to the rear wheels.

### Third Decision

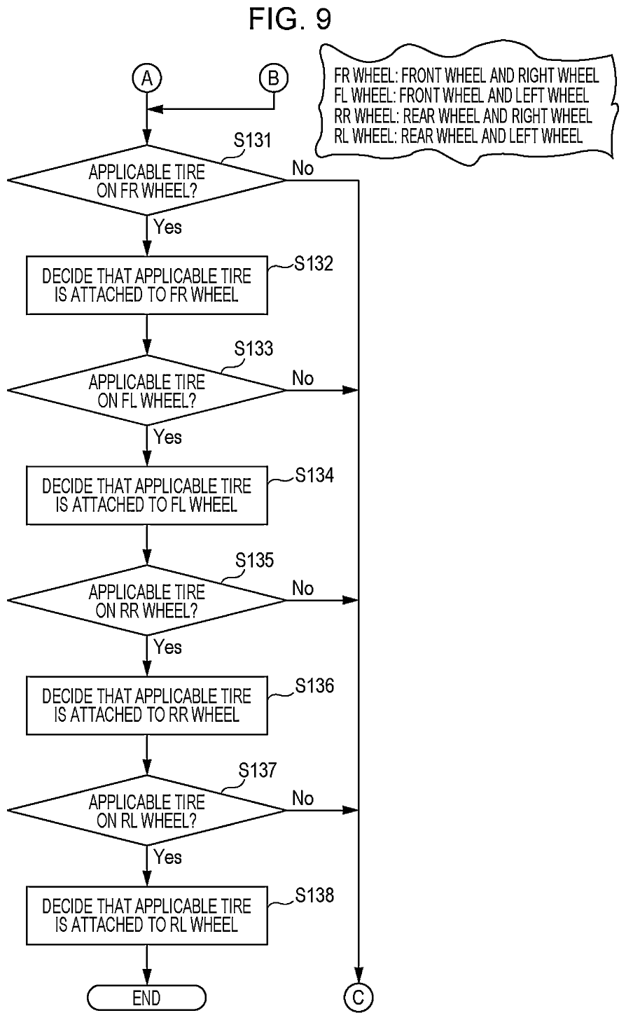

FIG. 9 is a flowchart for a process in a third decision, in the position inference process, in which a decision is made about the position of the wheel 11 to which the tire 10 is attached, according to the decision results in the first decision and second decision.

Following the first decision and second decision, which have been described with reference to FIGS. 7 and 8, the control unit 23 decides whether there is a tire 10 applicable to an FR wheel (front wheel on the right) according to the decision results in the first decision and second decision (S131). If the control unit 23 decides that there is a tire 10 applicable to the FR wheel (Yes in S131), the control unit 23 decides that the applicable tire 10 is attached to the FR wheel (S132). If the control unit 23 decides that there is no applicable tire 10 (No in S131), the control unit 23 makes the first decision and second decision again. The decision in S131 will be described in detail. The control unit 23 decides that the tire 10 decided in the first decision to be an inner wheel when the turn direction is to the right or an outer wheel when the turn direction is to the left and also decided in the second decision to be a front wheel is attached to the FR wheel.

As in S131 and S132, a decision is made about the position of the wheel 11 to which the applicable tire 10 is attached for an FL wheel (front wheel on the left) in S133 and S134, an RR wheel (rear wheel on the right) in S135 and S136, and an RL wheel (rear wheel on the left) in S137 and S138. If the control unit 23 decides that for all wheels 11, applicable tires 10 are attached, the third decision is terminated. Decisions as to whether the applicable tire 10 are attached are not limited to the sequence, illustrated in FIG. 9, starting from the FR wheel, followed by the FL wheel, RR wheel, and RL wheel in that order. It suffices to make decisions about the four wheels 11 in succession.

According to the processes above, the tire position identification device 1 in this embodiment decides that the tire 10 ranked in the first or second place in terms of the revolution speed and ranked in the first or second place in terms of the magnitude of the load is attached to the front wheel on the side distant from the center of a turn, the tire ranked in the first or second place in terms of the revolution speed and ranked in the third or fourth place in terms of the magnitude of the load is attached to the rear wheel on the side distant from the center of the turn, the tire ranked in the third or fourth place in terms of the revolution speed and ranked in the first or second place in terms of the magnitude of the load is attached to the front wheel on the side close to the center of the turn, and the tire ranked in the third or fourth place in terms of the magnitude of the revolution speed and ranked in the third or fourth place in terms of the load is attached to the rear wheel on the side close to the center of the turn.

### Variation

When the vehicle 2 is a front-wheel-drive vehicle or rear-wheel-drive vehicle, in which two of the four wheels 11 are driving wheels and the remaining two are non-driving wheels, a fourth decision to infer which wheel, a driving wheel or a non-driving wheel, is applicable may be made instead of (or in addition to) the second decision described above to make a decision about the position of the tire 10.

### Fourth Decision

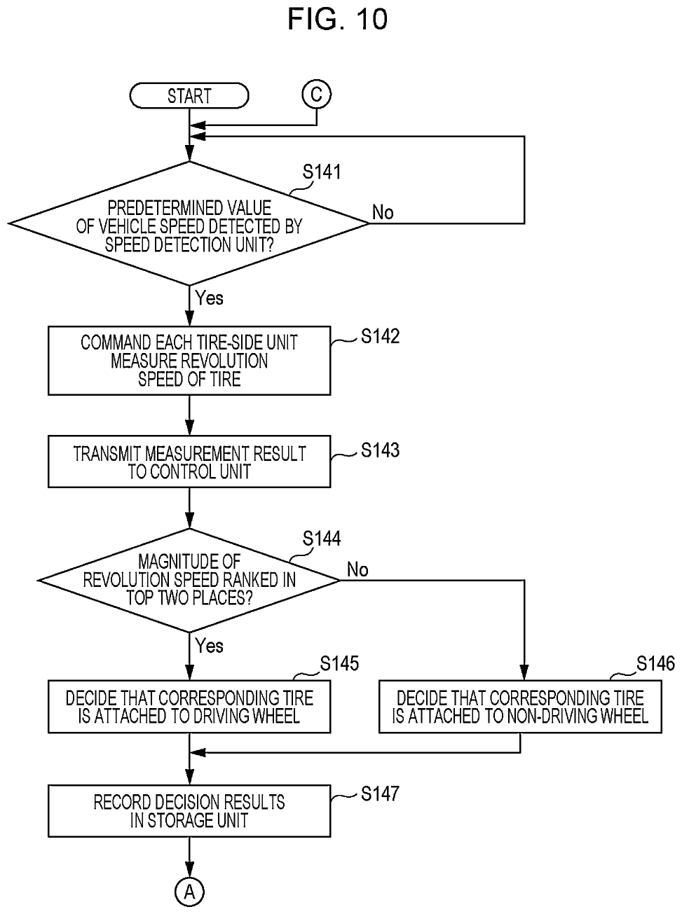

FIG. 10 is a flowchart for a process in a fourth decision, in the position inference process, in which it is decided that the tire 10 is attached to which wheel 11, a driving wheel or a non-driving wheel.

When the position inference process starts, the speed detection unit 22 detects whether the vehicle speed has reached a predetermined value at the time of the start of the vehicle 2 (S141). Here, an arbitrary vehicle speed of, for example, about 20 km/h or more and 50 km/h or less can be used as the predetermined value. If the speed detection unit 22 detects that the vehicle speed has not reached the predetermined value (No in S141), the speed detection unit 22 continues to detect the vehicle speed. If the speed detection unit 22 detects that the vehicle speed has reached the predetermined value (Yes in S141), the control unit 23 commands each tire-side unit 14 to measure the revolution speed of the relevant tire 10 (S142). Next, each tire-side unit 14 transmits a measurement result to the control unit 23 through the communication unit 13 and communication unit 24 (S143).

Next, the control unit 23 decides whether the magnitude of the revolution speed of each tire 10 to which the tire-side unit 14 is attached is ranked in top two places, by using the measurement results transmitted from the four tire-side units 14 (S144).

If the control unit 23 decides that the revolution speed of the tire 10 is ranked in top two places (Yes in S144), the control unit 23 decides that the tire 10 is attached to a driving wheel (S145).

The control unit 23 decides that the revolution speed of the tire 10 is not ranked in top two places (No in S144), the control unit 23 decides that the tire 10 is attached to a non-driving wheel (S146).

Next, the control unit 23 records, in the storage unit 25, the decision results in S145 and S146 (S147), and executes the position inference process for four wheels, which will be described later. The control unit 23 may shift to the position inference process without performing recording in the storage unit 25.

According to the process above, the control unit 23 can decide which wheel 11, a driving wheel or a non-driving wheel, the tire 10 is attached to, according to the revolution speed, of the tire 10, detected by using an output from the deformation detection unit 12 at the time when acceleration (start) is detected by the speed detection unit 22 while the vehicle 2 is traveling straight ahead.

The control unit 23 ranks the tires 10 in descending order of the revolution speed at the time when a start is detected by the speed detection unit 22, and decides that the tires 10 in as many top places as there are driving wheels are attached to the driving wheels and the remaining tires 10 are attached to the non-driving wheels. Specifically, when the number of driving wheels is 2, the tires 10 in as many top places as there are driving wheels are tires 10 in top two places.

### Fifth Decision

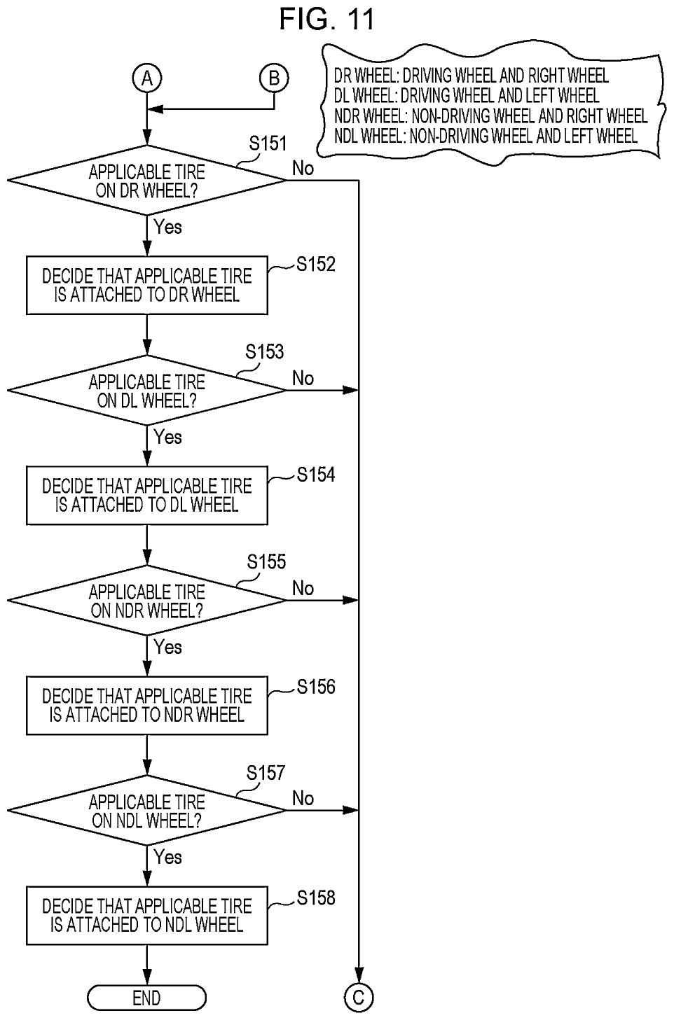

FIG. 11 is a flowchart for a process in a fifth decision in which the position of the wheel to which the tire 10 is attached is inferred according to the decision results in the first decision and fourth decision.

Following the first decision and fourth decision, which have been described with reference to FIGS. 7 and 10, the control unit 23 decides whether there is a tire 10 applicable to a DR wheel (driving wheel on the right) according to decision results (S151). If the control unit 23 decides that there is an applicable tire 10 (Yes in S151), the control unit 23 decides that the applicable tire 10 is attached to the DR wheel (S152). If the control unit 23 decides that there is no applicable tire 10 (No in S151), the control unit 23 makes the first decision and fourth decision again.

As in S151 and S152, a decision is made about the position of the wheel 11 to which the applicable tire 10 is attached for a DL wheel (driving wheel on the left) in S153 and S154, an NDR wheel (non-driving wheel on the right) in S155 and S156, and an NDL wheel (non-driving wheel on the left) in S157 and S158. If the control unit 23 decides that for all wheels, applicable tires 10 are attached, the fifth decision is terminated. The presence or absence of the applicable tire 10 only needs to be decided in succession for the four wheels 11, without being limited to the sequence illustrated in FIG. 11.

Since which wheels, the front wheels or rear wheels, are driving wheels is recorded in the storage unit 25, the position of the wheel 11 to which the tire 10 is attached can be identified from decision results in the first decision and fourth decision described above.

### Second Embodiment

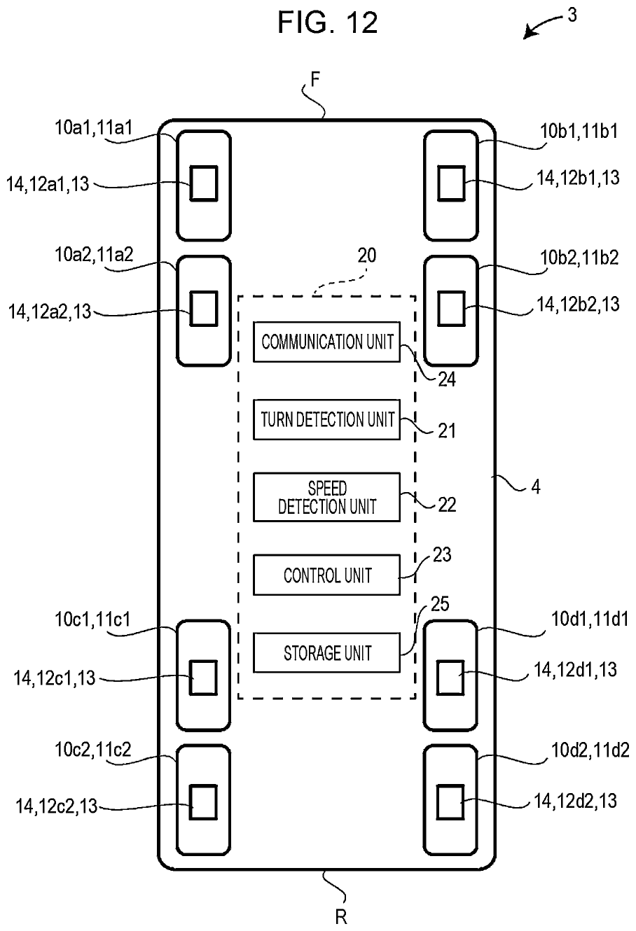

FIG. 12 is a block diagram of a tire position identification device 3 according to this embodiment. As indicated in the drawing, a vehicle 4 will be described below that has wheels 11a1, 11a2, 11b1, and 11b2, which are arranged on the left and right on the front side F in two rows in the front-back direction, as the front wheels, and also has wheels 11c1, 11c2, 11d1, and 11d2, which are arranged on the left and right on the rear side R in two rows in the front-back direction, as the rear wheels.

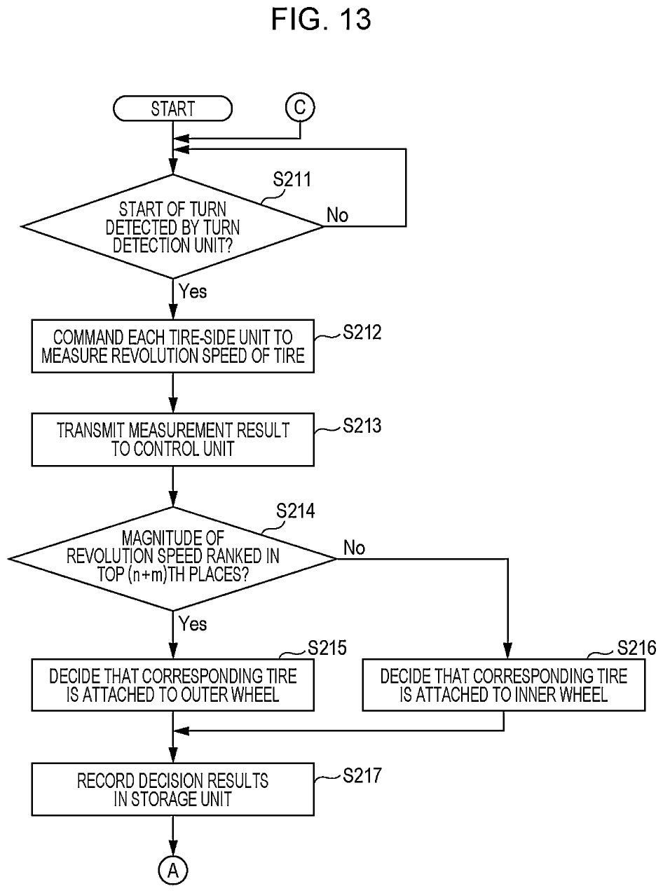

A tire position identification process executed in the tire position identification device 3 will be described below with reference to FIGS. 13 to 15.

### First Decision

FIG. 13 is a flowchart for a first decision, in the position inference process, in which it is decided that the tire 10 is attached to which wheel, a left wheel or a right wheel.

When the position inference process starts, the turn detection unit 21 detects whether a turn of the vehicle 4 has been started (S211). If the turn detection unit 21 has not detected the start of a turn (No in S211), the turn detection unit 21 continues to detect the start of a turn. If the turn detection unit 21 has detected the start of a turn (Yes in S211), the control unit 23 commands each tire-side unit 14 to measure the revolution speed of the relevant tire 10 (S212). Next, each tire-side unit 14 transmits a measurement result to the control unit 23 through the communication unit 13 and communication unit 24 (S213).

By using the revolution speeds of the tires 10 (10a1 to and 10a2 to 10d2) that were detected according the outputs, which are measurement results sent from eight tire-side units 14, of the deformation detection units 12 (12a1 to 12d1 and 12a2 to 12d2), the control unit 23 decides whether the revolution speed of each tire 10 to which the tire-side unit 14 is attached is ranked in top four places (S214). Assuming that the front wheels are arranged in n rows and the rear wheels are arranged in m rows, the control unit 23 decides whether the revolution speed is ranked in top (n+m)th places in S214. Specifically, as for the vehicle 4, both n and m are 2, so the control unit 23 decides whether the revolution speed is ranked in top four places.

If the control unit 23 decides that the revolution speed of the tire 10 is ranked in top four places (Yes in S214), the control unit 23 decides that the tire 10 is attached to an outer wheel (S215). If the control unit 23 decides that the revolution speed is not ranked in top four places (No in S214), the control unit 23 decides that the tire 10 is attached to an inner wheel (S216). The control unit 23 records, in the storage unit 25, the decision results in S215 and S216 (S217), and executes the position inference process for eight wheels, which will be described later.

As described above, in the first decision, the control unit 23 may rank the tires 10 in descending order of the revolution speed, and may decide that a top half is attached to the wheels 11 on the outer side with respect to the center of a turn and that a bottom half is attached to the wheels 11 on the inner side with respect to the center of the turn. When wheels 11 are arranged on each of the left and right on the front side of the vehicle in n rows (n 1) in the front-back direction as the front wheels and wheels 11 are arranged on each of the left and right on the rear side of the vehicle in m rows (m 1) in the front-back direction as the rear wheels, the tire position identification device 3 may rank the tires 10 in descending order of the revolution speed and may decide that the tires 10 ranked in the first place to the (n+m)th place in terms of the revolution speed are attached to the wheels 11 on the side distant from the center of the turn of the vehicle 4.

### Second Decision

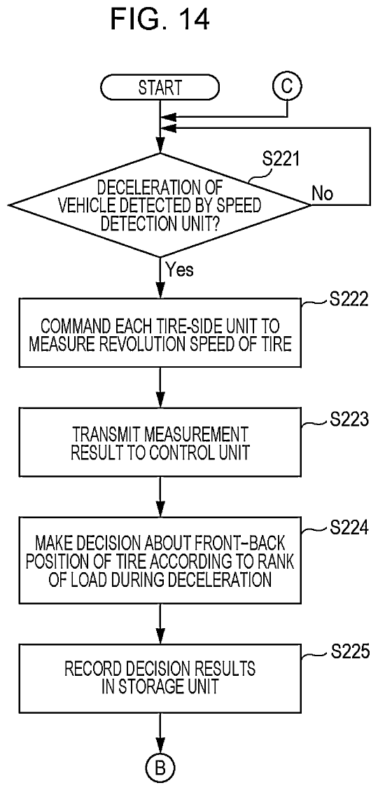

FIG. 14 is a flowchart for a second decision, in the position inference process, in which a decision is made about the front-back position of the wheel 11 to which the tire 10 is attached.

When the position inference process starts, the speed detection unit 22 detects whether the vehicle 4 has been decelerated while the vehicle 4 is traveling straight ahead (S221). If the speed detection unit 22 has not detected deceleration (No in S221), the speed detection unit 22 continue to detect deceleration. If the speed detection unit 22 has detected deceleration (Yes in S221), the control unit 23 commands each tire-side unit 14 to measure the deformation of the relevant tire 10 (S222). Next, each tire-side unit 14 transmits a measurement result to the control unit 23 through the communication unit 13 and communication unit 24 (S223).

Then, the control unit 23 makes a decision about the front-back position of the tire 10 according to the rank of the magnitude of the load during deceleration (S224). The control unit 23 records, in the storage unit 25, the decision results in S224 (S225), and executes the position inference process for eight wheels, which will be described later.

As described above, when wheels 11 are arranged on each of the left and right on the front side of the vehicle in n rows (n≥1) in the front-back direction as the front wheels and wheels 11 are arranged on each of the left and right on the rear side of the vehicle in m rows (m≥1) in the front-back direction as the rear wheels, the tire position identification device 3 may rank the tires 10 in descending order of the magnitude of the load at the time when deceleration (braking) is detected by the speed detection unit 22, and may decide that the tires 10 ranked in the first place to (2×n)th place in terms of the magnitude of the load are attached to the front wheels. The control unit 23 may decide that among the tires 10 decided to be attached to the front wheel or rear wheel, tires 10 having larger loads have been attached to the wheels 11 on the front side in an order starting from the tire 10 having the largest load.

### Third Decision

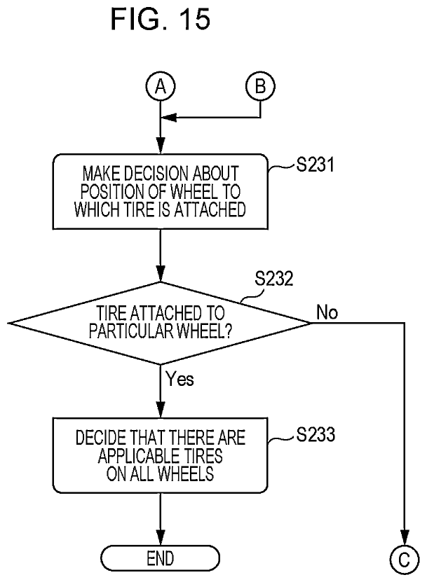

FIG. 15 is a flowchart for a process in a third decision, in the position inference process, in which a decision is made about the position of the wheel 11 to which the tire 10 is attached, according to the decision results in the first decision and second decision.

Following the first decision and second decision, which have been described with reference to FIGS. 13 and 14, the control unit 23 makes a decision about the position of the wheel 11 to which the tire 10 is attached (S231). In this decision, the control unit 23 decides whether there is a tire attached to a certain wheel 11 (S232). If the control unit 23 decides that there is a tire 10 (Yes in S231), the control unit 23 decides that the applicable tire 10 is attached to the certain wheel 11. If the control unit 23 decides that there is no tire 10 (No in S231), the control unit 23 repeats the first decision and second decision. A decision is made for each wheel 11 as to whether there is an attached tire 10 (S232). If the control unit 23 decides that there is an attached tire 10 for all wheels 11 (S233), the third decision is terminated.

In the process described above, the tire position identification device 3 in this embodiment can identify the placement of tires 10 even for the vehicle 4 having six or more wheels 11.

In the first embodiment and second embodiment, a decision result as to which wheel the tire 10 is attached to may be obtained a plurality of times. Of the plurality of decision results, a decision result obtained at a predetermined ratio or more may be regarded as a final decision result. For example, it will be assumed that a result of a combination, which is called X1, of the tire 10 and wheel 11 is obtained as a decision result. When a similar decision is made 30 times, if the ratio at which the combination X1 is obtained is 90 percent or more, it is decided that the tire 10 is attached to the wheel 11 under the combination X1.

Alternatively, when a decision as to which wheel 11 the tire 10 is attached to is made a plurality of times, if the same decision result is obtained in succession a predetermined number of times, the decision result may be regarded as a final decision result. For example, it will be assumed that a result of a combination, which is called X1, of the tire 10 and wheel 11 is obtained as a decision result. When a similar decision is made 10 times, if the combination X1 is obtained in succession 10 times as the decision result, it is decided that the tire 10 is attached to the wheel 11 under the combination X1.

By making an arrangement as in the examples described above, it is possible to make a mistaken decision less likely to occur that may occur due to effects of the inclination, projections and depressions, and the like of a load surface. It suffices to appropriately set the number of times, the ratio, and the like in decisions, according to the type of the vehicle to which tires are attached and the like.

The tire position identification device in an embodiment of the present invention can be preferably used as a device that infers the position of a wheel to which a tire having an evaluation device that evaluates the state of a tire is attached.

1. A tire position identification device that identifies a position of a wheel to which a tire is attached, the device comprising:
processing circuitry configured to:
detect deformation of the tire;
detect whether a vehicle having the tire and the wheel has made a turn and a turn direction;
detect a speed of the vehicle; and
determine the position of the wheel to which the tire is attached, according to the detected deformation, the turn direction, and the speed.

2. The tire position identification device according to claim 1, wherein
processing circuitry is further configured to:
determine, in a first decision, that the tire is attached to the wheel on which side, an outer side or an inner side, with respect to a center of the turn of the vehicle, by using a revolution speed of the tire at a time when the turn of the vehicle is detected, the revolution speed being detected according to the deformation of the tire,
determine, in a second decision, that the tire is attached to the wheel in which direction of the vehicle forward or backward, by using a load to the tire at a time when a change in speed is detected while the vehicle is traveling straight ahead, the load being detected according to the deformation of the tire, and
determine, in a third decision, the position of the wheel to which the tire is attached according to results in the first decision and the second decision.

3. The tire position identification device according to claim 2, wherein, in the first decision, when a right turn of the vehicle is detected and when a left turn is detected, a decision is made regarding which side, between the outer side or the inner side, the tire is attached to the wheel with respect to the center of the turn of the tire, by using the revolution speed of the tire, the revolution speed being detected according to the deformation of the tire.

4. The tire position identification device according to claim 2, wherein:
the vehicle has front wheels, one on each side in a left-right direction, and also has rear wheels one on each side in the left-right direction;
in the first decision, the tires are ranked in descending order of the revolution speed, the tires ranked in a first place and a second place in terms of the revolution speed are determined to be attached to the wheels on a side distant from the center of the turn of the vehicle, and the tires ranked in a third place and a fourth place in terms of the revolution speed are determined to be attached to the wheels on a side close closest to the center of the turn of the vehicle; and
in the second decision, when deceleration is detected, the tires are ranked in descending order of a magnitude of the load applied to the tire, and the tires ranked in a first place and a second place in terms of the magnitude of the load are determined to be attached to the front wheels, and the tires ranked in a third place and a fourth place in terms of the magnitude of the load are determined to be attached to the rear wheels.

5. The tire position identification device according to claim 2, wherein:
with the vehicle, wheels are arranged on each of a left and a right on a front side of the vehicle in n rows (n≥1) in a front-back direction as front wheels and wheels are arranged on each of the left and the right on a rear side of the vehicle in m rows (m≥1) in the front-back direction as rear wheels;
in the first decision, the tires are ranked in descending order of the revolution speed, the tires ranked in a first place to an (n+m)th place in terms of the revolution speed are decided to be attached to the wheels distant from the center of the turn of the vehicle;
in the second decision, the tires are ranked in descending order of magnitude of the load at a time when deceleration is detected, and the tires to which magnitudes of loads ranked in a first place to a (2×n)th place are applied are decided to be attached to the front wheels.

6. The tire position identification device according to claim 4, wherein, in the second decision, an interval between peaks in a graph indicating the deformation is used to decide that as the interval between the peaks becomes longer, a magnitude of the load increases.

7. The tire position identification device according to claim 1, wherein the processing circuitry is further configured to:
determine, in a first decision, which side the tire is attached to the wheel an outer side or an inner side, with respect to a center of the turn of the vehicle, by using a revolution speed of the tire at a time when the turn of the vehicle is detected, the revolution speed being detected according to the deformation, and
determine, in a second decision, which wheel, a driving wheel or a non-driving wheel, the tire is attached to, according to the revolution speed of the tire at a time when acceleration is detected while the vehicle is traveling straight ahead, the revolution speed being detected by using the deformation, and
determine, in a third decision, the position of the wheel to which the tire is attached according to results in the first decision and the second decision.

8. The tire position identification device according to claim 7, wherein:
in the first decision, the tires are ranked in descending order of the revolution speed, a top half is decided to be attached to the wheels on the outer side with respect to the center of the turn, and a bottom half is decided to be attached to the wheels on the inner side with respect to the center of the turn, and
in the second decision, the tires are ranked in descending order of the revolution speed at a time when acceleration is detected, tires in as many top places as there are driving wheels are decided to be attached to driving wheels, and remaining tires are decided to be attached to non-driving wheels.

9. The tire position identification device according to claim 1, wherein the processing circuitry is further configured to determine the position of the wheel to which the tire is attached, according to the deformation of the tire that continuously rotates five times or more, the turn direction, and the speed.

10. The tire position identification device according to claim 1, wherein the processing circuitry is further configured to determine the position of the wheel to which the tire is attached, according to the deformation, the turn direction, and the speed while the vehicle is traveling at a speed of 50 km/h or less.

11. The tire position identification device according to claim 1, wherein the processing circuitry is further configured to implement detection of a wear state of the tire according to the deformation of the tire.

12. A tire position identification method of identifying a position of a wheel to which a tire is attached, the method comprising:
detecting deformation of the tire;
detecting whether a vehicle having the tire and the wheel has made a turn as well as a turn direction;
detecting a speed of the vehicle; and
determining, using processing circuitry, the position of the wheel to which the tire is attached according to the deformation, the turn direction, and the speed.

13. A non-transitory computer readable medium having stored thereon a computer program that when executed by a computer causes the computer to implement the method according to claim 12.

14. A tire position identification device that identifies a position of a wheel to which a tire is attached, the device comprising:
deformation detection means for detecting deformation of the tire;
turn detection means for detecting whether a vehicle having the tire and the wheel has made a turn and also detecting a turn direction;
speed detection means for detecting a speed of the vehicle; and
position inference means for determining the position of the wheel to which the tire is attached, according to the detected deformation, the turn direction, and the speed.

15. The tire position identification method according to claim 12, further comprising:
determining, in a first decision, that the tire is attached to the wheel on which side, an outer side or an inner side, with respect to a center of the turn of the vehicle, by using a revolution speed of the tire at a time when the turn of the vehicle is detected, the revolution speed being detected according to the deformation of the tire;
determining, in a second decision, that the tire is attached to the wheel in which direction of the vehicle forward or backward, by using a load to the tire at a time when a change in speed is detected while the vehicle is traveling straight ahead, the load being detected according to the deformation of the tire; and
determining, in a third decision, the position of the wheel to which the tire is attached according to results in the first decision and the second decision.

16. The tire position identification device according to claim 14,
wherein the position inference means further includes means for determining, in a first decision, that the tire is attached to the wheel on which side, an outer side or an inner side, with respect to a center of the turn of the vehicle, by using a revolution speed of the tire at a time when the turn of the vehicle is detected by the turn detection means, the revolution speed being detected according to the deformation of the tire,
determining, in a second decision, that the tire is attached to the wheel in which direction of the vehicle forward or backward, by using a load to the tire at a time when a change in speed is detected by the speed detection means while the vehicle is traveling straight ahead, the load being detected according to the deformation of the tire, and
determining, in a third decision, the position of the wheel to which the tire is attached according to results in the first decision and the second decision.

17. The tire position identification method according to claim 15, wherein, in the first decision, when a right turn of the vehicle is detected and when a left turn is detected, a decision is made regarding which side, between the outer side or the inner side, the tire is attached to the wheel with respect to the center of the turn of the tire, by using the revolution speed of the tire, the revolution speed being detected according to the deformation of the tire.

18. The tire position identification device according to claim 16, wherein, in the first decision, when a right turn of the vehicle is detected and when a left turn is detected, a decision is made regarding which side, between the outer side or the inner side, the tire is attached to the wheel with respect to the center of the turn of the tire, by using the revolution speed of the tire, the revolution speed being detected according to the deformation of the tire.

19. The tire position identification method according to claim 15, wherein:
the vehicle has front wheels, one on each side in a left-right direction, and also has rear wheels one on each side in the left-right direction;
in the first decision, the tires are ranked in descending order of the revolution speed, the tires ranked in a first place and a second place in terms of the revolution speed are determined to be attached to the wheels on a side distant from the center of the turn of the vehicle, and the tires ranked in a third place and a fourth place in terms of the revolution speed are determined to be attached to the wheels on a side closest to the center of the turn of the vehicle; and
in the second decision, when deceleration is detected, the tires are ranked in descending order of a magnitude of the load applied to the tire, and the tires ranked in a first place and a second place in terms of the magnitude of the load are determined to be attached to the front wheels, and the tires ranked in a third place and a fourth place in terms of the magnitude of the load are determined to be attached to the rear wheels.

20. The tire position identification device according to claim 16, wherein:
the vehicle has front wheels, one on each side in a left-right direction, and also has rear wheels one on each side in the left-right direction;
in the first decision, the tires are ranked in descending order of the revolution speed, the tires ranked in a first place and a second place in terms of the revolution speed are determined to be attached to the wheels on a side distant from the center of the turn of the vehicle, and the tires ranked in a third place and a fourth place in terms of the revolution speed are determined to be attached to the wheels on a side closest to the center of the turn of the vehicle; and
in the second decision, when deceleration is detected by the speed detection means, the tires are ranked in descending order of a magnitude of the load applied to the tire, and the tires ranked in a first place and a second place in terms of the magnitude of the load are determined to be attached to the front wheels, and the tires ranked in a third place and a fourth place in terms of the magnitude of the load are determined to be attached to the rear wheels.
